(19) United States
(12) Patent Application Publication
(10) Pub. No.: US 2007/0085655 A1
(43) Pub. Date: Apr. 19, 2007

(54) Biometric safe lock

(76) Inventors: Kelvin H. Wildman, Honeoye Falls, NY (US); Terri P. Cleveland, Holley, NY (US); David A. Furth, Skaneateles, NY (US); William Becker, Little Silver, NJ (US)

Correspondence Address: JAECKLE FLEISCHMANN & MUGEL, LLP, 190 Linden Oaks, ROCHESTER, NY, 14625-2812, US

(21) Appl. No.: 10/597,912

(22) PCT Filed: Feb. 10, 2005
(86) PCT No.: PCT/US05/04502

§ 371 Date: Aug. 11, 2006

Related U.S. Application Data
(60) Provisional application No. 60/543,777, filed on Feb. 11, 2004.

(51) Int. Cl. G06K 9/00; B60R 25/00; E05G 1/00

(52) U.S. Cl. 340/5.53; 340/5.73; 109/23

(57) ABSTRACT

A lock interface for a biometric lock is provided. The lock interface includes a body, a biometric sensor, and a biometric alignment feature. The biometric sensor is mounted to the body for reading a unique identifying characteristic of an individual. The alignment feature is associated with the sensor to assist a user in properly positioning the unique identifying characteristic with respect to the sensor. The present invention also includes a method for unlocking a safe using a biometric lock. The method comprises initiating the biometric lock by contacting the lock interface, recognizing a visual cue that indicates that a unique identifying characteristic is to be entered using the sensor, and entering the unique identifying characteristic feature using the sensor. The entered unique identifying characteristic is compared with a stored unique identifying characteristic, and the safe is unlocked if the unique identifying characteristic matches the stored unique identifying characteristic.

### CROSS-REFERENCE TO RELATED APPLICATIONS

This application claims the benefit of U.S. Provisional Patent Application No. 60/543,777, filed on Feb. 11, 2004.

### STATEMENT REGARDING FEDERALLY SPONSORED RESEARCH OR DEVELOPMENT

Not applicable.

### BACKGROUND OF THE INVENTION

The present invention relates to a biometric lock for a safe or other type of enclosure. In particular, the present invention is directed to a lock mechanism that utilizes a unique identifying characteristic of an individual in determining whether to allow access to an internal compartment of a safe. More particularly, the present invention is directed to a biometric safe lock that includes visual cues such as an instruction display, a crosshair identifier, and prompt Lighting Emitting Diodes (LED's) that are associated with a biometric sensor to assist the user in using the biometric safe lock. Furthermore, the present invention includes a biometric lock for administering access to the internal compartment of the safe.

It is known to use a biometric safe lock for securing various types of enclosures. For instance, known biometric safe locks may use a person's fingerprint to allow access to the interior portion of a safe. In order to gain access to the interior of the safe, a user may place his or her finger on a fingerprint sensor, the biometric lock interprets the information gathered from the sensor and determines whether or not the gathered fingerprint information is associated with an authorized user of the safe lock. If the safe lock does not recognize the information gathered by the sensor, it will deny access to the safe and the lock will remain in a locked position. If the lock recognizes the information gathered by the sensor, the locking mechanism is moved to an opened position to allow the user to access interior compartment 11 of safe 6.

However, known biometric locks present a number of drawbacks and deficiencies. For instance, these biometric safe locks do not provide any guidance to the user for properly positioning the fingerprint on the sensor. Improperly positioning a fingerprint on the sensor makes it difficult for the sensor to properly read and interpret the fingerprint. If the sensor is not able to read the fingerprint because of improper positioning, the lock will deny access to an authorized user, and the user will be required to restart the access procedure without knowing how to position his or her fingerprint on the sensor.

Another problem with prior art biometric locks is that a user may have a difficult time understanding what to do during the process of unlocking the biometric lock. Known biometric safe locks commonly utilize sounds, such as beeps, to instruct the user on how to proceed. Using only audible indicators may be confusing to the user and may require the user to refer to the operating manual to determine the meaning of the audible indicators, which may be a time consuming process.

Further, known biometric safe locks may include an administrator button that is located on an interior portion of the safe, which may be used to add or delete one or more authorized fingerprints stored in the biometric lock. In particular, the administrator button is typically located in an exposed location within the interior of the safe. Therefore, the administrator button may be utilized by anyone with access to the safe. Allowing access to the administrator button to anyone with access to the safe may be problematic since any of the users of the safe may use the administrator button to erase all fingerprint information stored in the biometric lock and deny access to the owner and the other users of the safe without the consent of the owner. Thus, unrestricted access to the administrator button prevents the owner or administrator from having exclusive control over who has access to the safe.

Accordingly, there exists a need for a biometric safe lock that assists the user in properly aligning his or her biometric indicator on the biometric sensor. In addition, there is a need for a biometric safe lock that provides additional visual cues that assist a user in operating the lock and reduces the need to refer to a separate instruction manual. Further, there is a need for a biometric lock that allows an administrator to prevent the general users of the safe from accessing the administrator button positioned within the safe. The present invention fills these needs as well as other needs.

### SUMMARY OF THE INVENTION

In order to overcome the above stated problems and limitations, there is provided a lock interface for a biometric lock, wherein the biometric lock is adapted to selectively restrict access to an enclosure. The lock interface includes a body, a biometric sensor, and a biometric alignment feature. The biometric sensor is mounted to the body for reading a unique identifying characteristic of an individual, such as a fingerprint. The biometric alignment feature is associated with the biometric sensor to assist a user in properly positioning the unique identifying characteristic with respect to the biometric sensor.

In one embodiment of the present invention, the biometric sensor may be rectangular and include a top boundary, a bottom boundary, a right boundary and a left boundary. The biometric alignment feature may include a first crosshair positioned adjacent to the top boundary, a second crosshair positioned adjacent to the bottom boundary, a third crosshair positioned adjacent to the right boundary, and a fourth crosshair positioned adjacent to the left boundary. The first crosshair, second crosshair, third crosshair, and fourth crosshair may provide a guide for placing the unique identifying characteristic on the biometric sensor. Moreover, the biometric sensor may have a first axis that bisects the top and bottom boundaries, and a second axis that bisects the right and left boundaries, wherein the first and second crosshairs lie on the first axis, and wherein the third and fourth crosshairs lie on the second axis. The first and second axes may be perpendicular to one another.

The present invention may further include a light emitting mechanism, such as a light emitting diode, associated with the biometric sensor for selectively illuminating the biometric sensor. In particular, a first portion of the body may be formed of a material that allows light to pass therethrough, wherein the light emitted by the light emitting mechanism is directed through the first portion and onto the biometric sensor. The lock interface may also include a display that is coupled with the body for conveying information to a user of the biometric lock.

The present invention may also include, in addition to the biometric lock, a key lock and an administrator locking mechanism. The biometric lock may be coupled with the enclosure and used to selectively lock and unlock the door relative to the body of the enclosure. The biometric lock may include a controller, a biometric sensor, and an administrator function. The biometric sensor is mounted to the body of the enclosure for reading a unique identifying characteristic of an individual. Further, the controller has a memory for storing at least one fingerprint read by the biometric sensor, and the administrator function is adapted to clear the at least one unique identifying characteristic stored in the memory. The key lock is coupled with the enclosure to selectively lock and unlock the door of the enclosure, wherein the biometric lock and the key lock independently operate to selectively lock and unlock the door of the enclosure. The administrator locking mechanism includes an axis and a cam member. The axis is coupled with the cam member and is adapted to change the position of the cam member when the key lock is moved between locked and unlocked positions. The cam member is positioned to restrict access to the administrator function when the key lock is in a locked position, and allows access to the administrator function when the key lock is in an unlocked position. Furthermore, the enclosure may include an actuator that operates to lock and unlock the door relative to the body of the enclosure, wherein the cam member interacts with the actuator to unlock the safe when the key lock is moved to an unlocked position.

The present invention also provides a method for unlocking a safe using a biometric lock. The biometric lock includes a locking mechanism and a lock interface having a biometric sensor and a display. The method comprises initiating the biometric lock by contacting at least a portion of the lock interface, such as a button, recognizing a visual cue that indicates that a unique identifying characteristic is to be entered using the biometric sensor, and entering the unique identifying characteristic feature using the biometric sensor. The entered unique identifying characteristic is compared with a unique identifying characteristic of an authorized user stored in a memory location within the biometric lock. The safe is unlocked if the entered unique identifying characteristic matches the stored unique identifying characteristic of an authorized user, and the safe remains locked if the entered unique identifying characteristic does not match the stored unique identifying characteristic of an authorized user.

### BRIEF DESCRIPTION OF THE SEVERAL VIEWS OF THE DRAWINGS

The above-mentioned and other features and advantages of this invention, and the manner of attaining them, will become apparent and be better understood by reference to the following description of one embodiment of the invention in conjunction with the accompanying drawings, wherein:

FIG. 1 is a front perspective view of a safe including a biometric lock having a lock interface in accordance with the present invention;

FIG. 2 is an enlarged front perspective view of the biometric lock interface shown in FIG. 1;

FIG. 3 is a schematic view of the biometric lock of the present invention;

FIG. 4 is a flow chart showing the use and operation of the biometric lock when an authorized user opens the safe;

FIG. 5 is a flow chart showing the use and operation of the biometric lock when a manager attempts to open the safe, enroll a fingerprint, or delete a fingerprint from the biometric lock;

FIG. 6 is a flow chart showing the use and operation of the biometric lock when an attempt is made to enroll a fingerprint;

FIG. 7 is a flow chart showing the biometric lock entering an administration mode;

FIG. 8 is a flow chart showing the operation of the biometric lock when access is denied;

FIG. 9 is a schematic drawing showing a lock cam member in a position to restrict access to an administration button; and

FIG. 10 is a schematic drawing similar to FIG. 9 showing a lock cam member engaging a safe actuator to unlock the safe, wherein the locking cam member is in a position to allow access to the administration button.

### DETAILED DESCRIPTION OF THE INVENTION

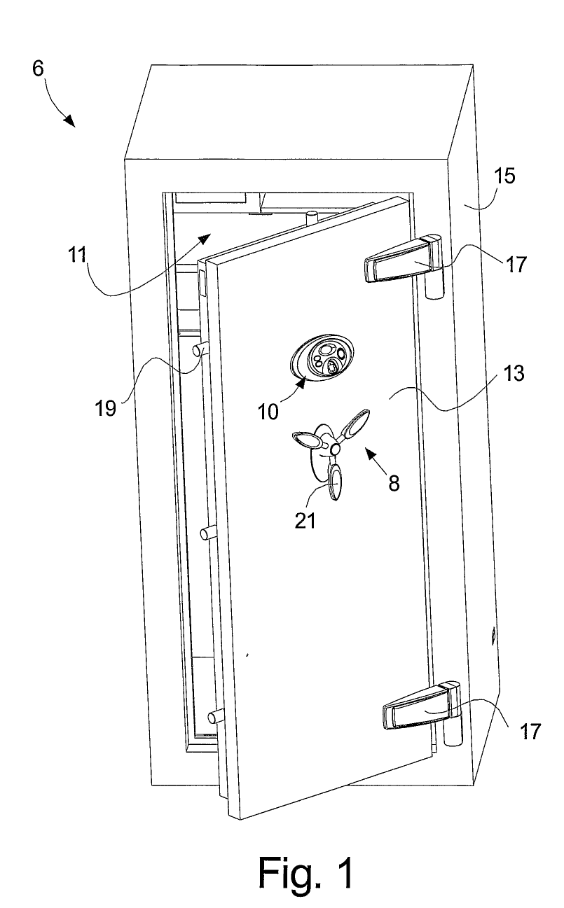

Referring to the drawings in detail, and particularly FIGS. 1-3, there is generally shown a safe or enclosure 6 including a biometric lock 8 having a biometric lock interface 10. Biometric lock 8 may be used to administer access to an internal compartment 11 of safe 6. Biometric lock 8 controls access to internal compartment 11 of safe 6 by comparing a person's unique identifying characteristic of against one or more previously enrolled images for the purpose of recognition. Biometric interface 10 generally includes a escutcheon plate or body 12 that may be mounted to the external surface of safe 6, such as a safe door 13. Door 13 may be hingedly coupled with a safe body 15 by one or more hinges 17.

Biometric interface 10 may also include a display 14, a biometric sensor 16, an enter button 18, and a pair of scroll buttons 20, 22. Further, biometric interface 10 may include transparent, translucent, or other type of surface 24 located within a recess 33 located near biometric sensor 16, around the enter button 18, and around scroll buttons 20, 22 that will allow light emitted from one or more backlight Light Emitting Diodes (LEDs) 26 to pass therethrough. The light passing through surfaces 24, in conjunction with display 14, provides the user with visual cues to assist in operating biometric lock 8.

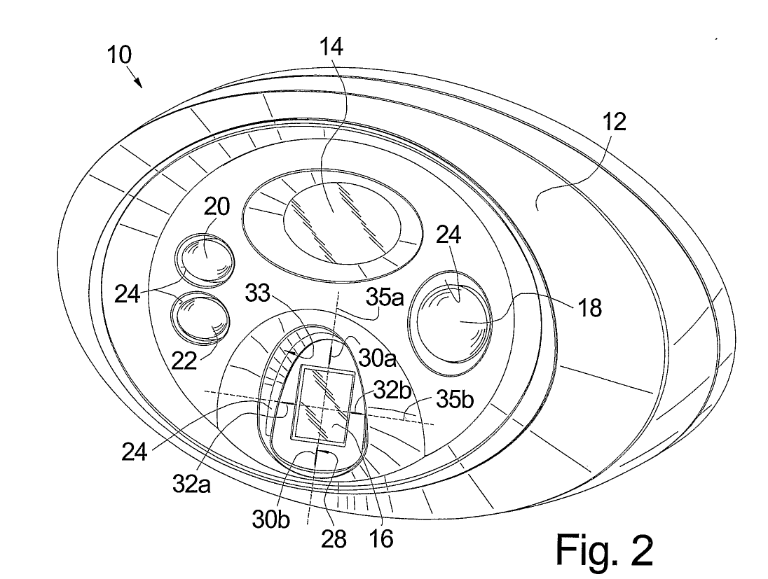

As best seen in FIG. 2, biometric interface 10 may also include a biometric alignment feature 28 that is positioned near biometric sensor 16 to guide the user in properly positioning his or her unique identifying characteristic, such as a fingerprint, in a readable location on biometric sensor 16. Biometric alignment feature 28 may include one or more crosshairs 30a, 30b, 32a, 32b that are positioned on biometric interface 10 to identify an acceptable target area for a user to place the thick or pad portion of his or her fingerprint on biometric sensor 16. Placing the fingerprint on biometric sensor 16 is important so that biometric sensor 16 is able to read the fingerprint.

For instance, crosshairs 30a, 30b may be aligned with each other, extend vertically, and positioned on opposite sides of biometric sensor 16. Further, crosshairs 32a, 32b may be aligned with each other, extend horizontally, and positioned on opposite sides of biometric sensor 16. In particular, biometric sensor 16 may be rectangular shaped and include a top boundary 16a, a bottom boundary 16b, a right boundary 16c, and a left boundary 16d. Biometric sensor 16 may also include a first axis 35a and a second axis 35b that may be perpendicular relative to one another. First axis 35a may be positioned relative to biometric sensor 16 so that it bisects top boundary 16a and bottom boundary 16b. Second axis 35b may be positioned relative to biometric sensor 16 so that it bisects right boundary 16c and left boundary 16d. In one arrangement, crosshair 30a may be positioned above top boundary 16a and crosshair 30b may be positioned below bottom boundary 16b, wherein crosshairs 30a, 30b lie on first axis 35a of biometric sensor 16. Further, crosshair 32a may be positioned to the left of left boundary 16d and crosshair 32b may be positioned to the right of right boundary 16c, wherein crosshairs 32a, 32b lie on second axis 35b of biometric sensor 16.

It will be understood and appreciated that biometric alignment feature 28 may take other forms, such as dots or arrows, so long as the feature directs the user to properly position his or her unique identifying feature on biometric sensor 16 so that an adequate reading can be taken. Further, biometric sensor 16 may be circular, oval or another shape that allows a user to place his or her fingerprint or other biometric feature on or near the sensor. For example, if the biometric sensor 16 is oval shaped, first and second axes may be aligned with the major and minor axes of the oval.

The present invention uses fingerprint identification as the identifying characteristic, therefore biometric sensor 16 may be either a capacitance or optical fingerprint sensor, such as a FUJITSU MBF200 Capacitive Sensor. While the present invention uses a person's fingerprint as the unique identifying feature that will unlock biometric safe 8, it will be understood that any unique identifying living or human characteristic, such as, but not limited to voice recordings, irises, facial images and the like may be read by biometric sensor 16. Biometric sensor 16 may be positioned within a recess 33 formed in body 12 of biometric interface 10. Moreover, body 12 may be constructed in such a way that the biometric interface 10 is angled upwardly relative to the surface of safe 6 that biometric interface 10 is mounted on so it is easier for a user to place his or her finger on biometric sensor 16, access the enter button 18 and scroll buttons 20, 22 and read the information set forth on display 14.

Display 14 may be a Liquid Crystal Display (LCD) screen that is adapted to provide visual cues or prompts to provide a user with instructions or information during operation of the biometric lock 8. The types of instructions or information that may be provided on display 14 include text prompts or symbols to provide directions to a user, a battery level indicator that informs the user of the power remaining in the biometric lock 8, and other information. Likewise, the visual cues provided to a user by the background LEDs that selectively emit light on the biometric sensor 16 also provide direction to a user as to what steps are required to proceed with either gaining access to safe 6 or add/delete one or more unique identifying characteristics from biometric lock 8.

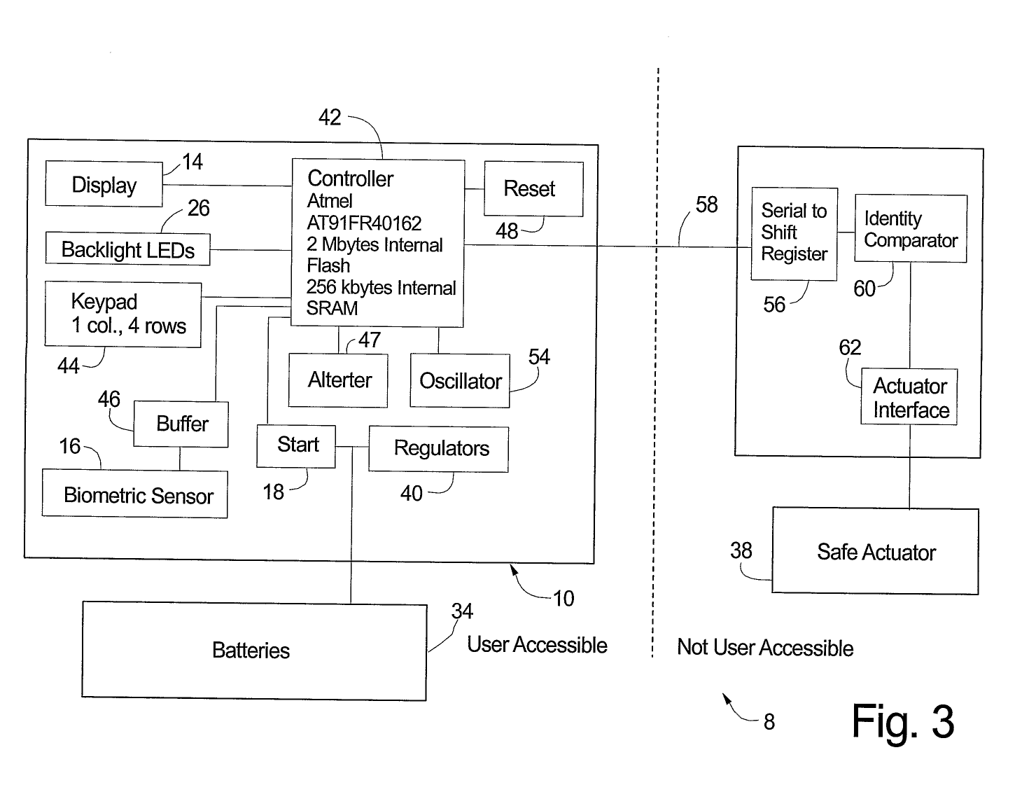

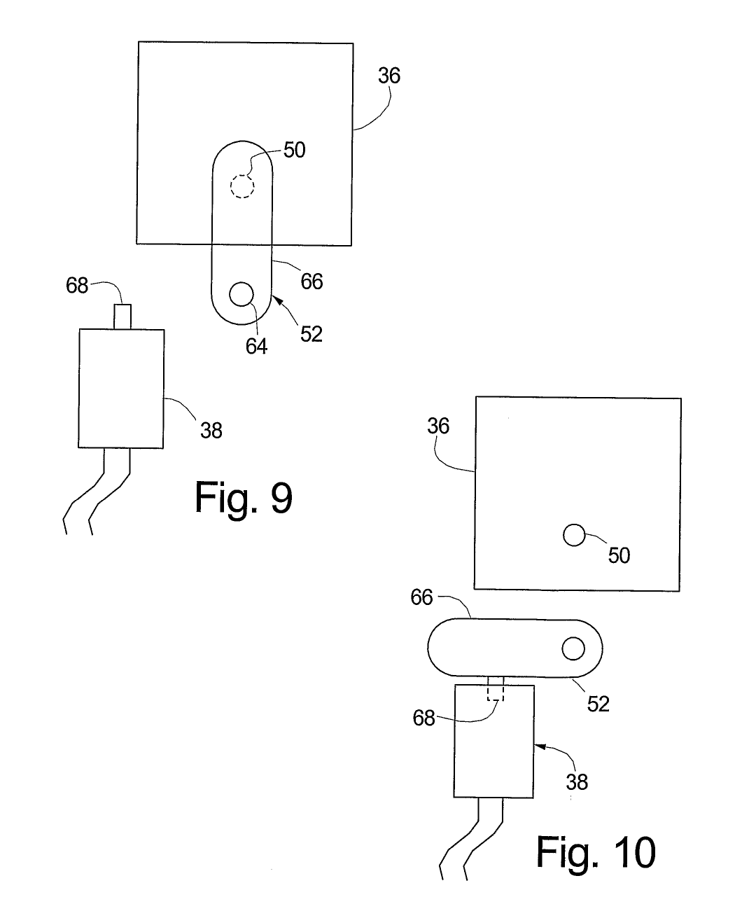

As best seen in FIG. 3, biometric lock 8 includes biometric lock interface 10 and a power source 34, such as a battery, that are user accessible. In addition, biometric lock 8 includes an actuator printed writing board (PWB) 36 and a safe actuator 38 that are not user accessible. Further, a start or enter button 18 is connected to one or more regulators and power source 34. Power source 34 may be in the form of a battery that provides the necessary power to operate the components of biometric lock 8. When the start or enter button 18 is initiated, power from power source 34 is directed to a controller 42. Controller 42 is a processor which includes a memory for storing fingerprints and other information. Controller 42 is connected to display 14, backlight LEDs 26 and a keypad matrix 44, which may be used to transfer input commands from a user through the use of scroll buttons 20, 22. Biometric sensor 16 is connected to a buffer 46 that is used to regulate the rate of flow of data between sensor 16 and controller 42. Biometric interface 10 also includes an alerter 47 that is connected to controller 42 and may be used to provide a visual, audible or other type of signal to a user. A reset 48 is connected to controller 42 which may be used to clear any fingerprint data or other type of information stored in the memory of controller 42. Reset 48 is connected to an administrator button or function 50 (FIGS. 9 and 10) that may be mounted to actuator printed writing board 36 and accessed when safe door 13 is unlocked by an administrator using a key. Administrator button 50 is a feature of biometric lock 8 in that may be used to delete all of the authorized fingerprints stored in the biometric lock. Therefore, access to internal administrator button 50 may be selectively secured through the use of an administrator locking mechanism 52, which will be discussed in more detail below. An oscillator 54 may be connected to controller 42 and provides timing for the communication between controller 42 and a serial shift register 56 located on actuator printed wiring board 36.

Shift register 56 is connected to controller 42 through the use of a four-wire interface 58. For security purposes, the communication between controller 42 and shift register may be encrypted in such a way that the voltage pulses are unique for each safe. Shift register 56 is connected to an identity comparator 60, which is in turn connected to an actuator interface 62. Actuator interface 62 is connected to safe actuator 38 and provides the signals necessary to unlock safe 6 through the use of a solenoid or other type of locking mechanism.

A conventional locking mechanism, such as a key lock, may be mounted to safe 6, specifically, behind the escutcheon plate 12. Escutcheon plate 12 is adapted to be pivoted outwardly to allow access to the key lock. The key lock may be moved between locked and unlocked positions using a key to provide an alternative way of gaining access to safe 6. In accordance with the present invention, administrator locking mechanism 52 is associated with the conventional locking mechanism in such a manner to allow access to administrator button 50 when the key is turned to an unlocked position so that the memory of biometric lock 10 maybe reset or cleared. It will be understood and appreciated that an administrator of biometric lock 8 is the person who has access to the key for the conventional locking mechanism.

As best seen in FIG. 9, administrator button 50 is located on actuator printed writing board 36. In addition, the conventional locking mechanism is coupled with administrator locking mechanism 52, wherein the administrator locking mechanism 52 has an axis 64 that is adapted to rotate as the key rotates between the locked and unlocked position. A cam member 66 is coupled with lock axis 64 and is adapted to rotate in conjunction with lock axis 64. As best seen in FIG. 9, when the conventional locking mechanism is positioned in a locked position, cam member 66 is positioned in such a way to cover or otherwise restrict access to administrator button 50. Therefore, if a general or non-administrator user gains access to internal compartment 11 of safe 6 through the use of biometric lock 8, he or she will not be able to access to administrator button 50 as long as the conventional locking mechanism is in a locked position and cam member 66 is covering the administrator button 50.

As best seen in FIG. 10, conventional locking mechanism may be moved to a unlocked position through the use of a key. As the key is turned from the locked position (FIG. 9), lock axis 64 rotates counterclockwise, which also causes cam member 66 to rotate in a counterclockwise direction. As lock axis 64 and cam member 66 are rotated in a counterclockwise direction, cam member 66 depresses an actuator button 68 on actuator 38 to unlock safe 6. Further, the rotation of cam member 66 operates to expose administrator button 50 and allow someone to reset or clear the fingerprint information stored in controller 42. Administrator button 50 may be used until the cam member 66 is positioned in such a way to restrict access to administrator button 50, as shown in FIG. 9.

Biometric lock 8 has the capacity to store in memory one or more fingerprints for two managers and six general users who are permitted to unlock the locking mechanism to access to interior compartment 11 of safe 6. A manager not only has the ability to gain access to safe 6 by using his or her fingerprint to open the biometric lock 8, the manager also has the authority to add and delete general users from the memory of biometric lock 8 using his or her unique identifying charateristic. As stated above, the administrator of biometric lock 8 is the person who has access to the key for the conventional locking mechanism, and thus may access administrator button 50 and reset or clear the memory in biometric lock 8. The general users of the biometric lock 8 only have the ability to gain access to safe 6 by using his or her fingerprint to open the biometric lock 8. The general users are not able to add or delete any other general users or managers, unless the general user is the administrator in which case the general user has the ability to access administrator button 50 and reset or clear the memory in biometric lock 8. Preferably, each of the managers and general users may be required to store two fingerprints (e.g., thumb and index fingerprint) in biometric lock 8 to gain access to safe 6. However, it will be understood that more or less fingerprints may be required depending at least in part on the desired level of security for safe 6. Further, it is within the scope of the present invention to include any number of managers or general users in biometric lock 8.

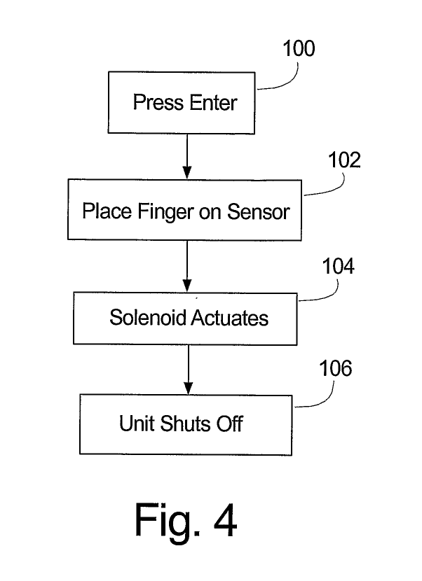

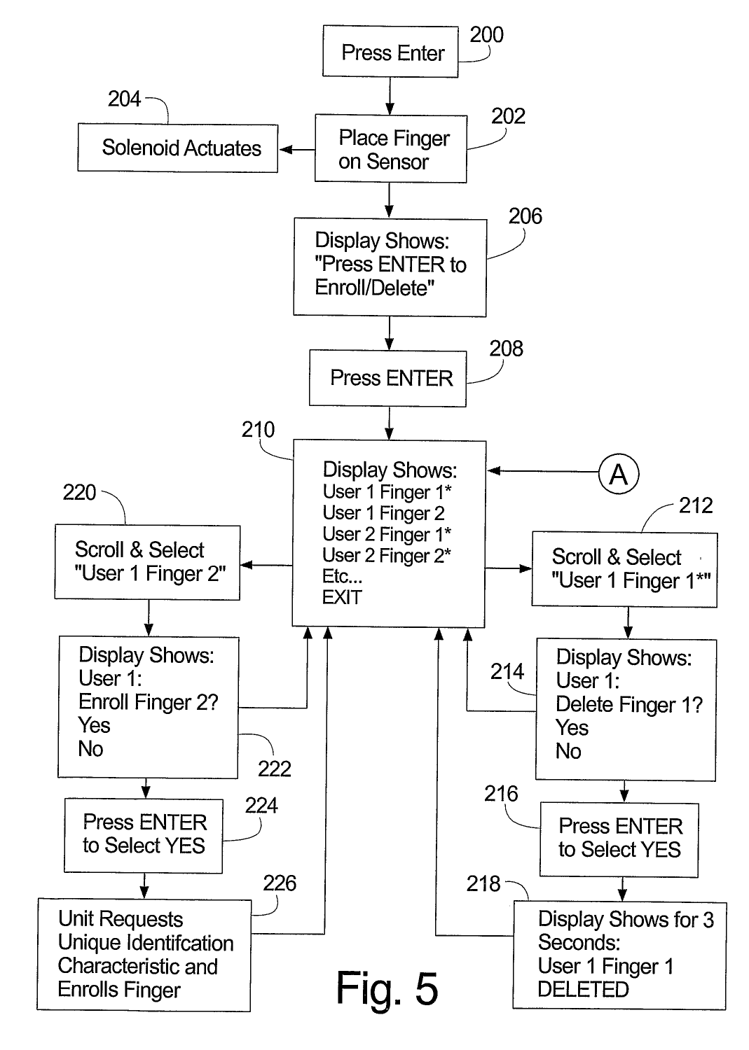

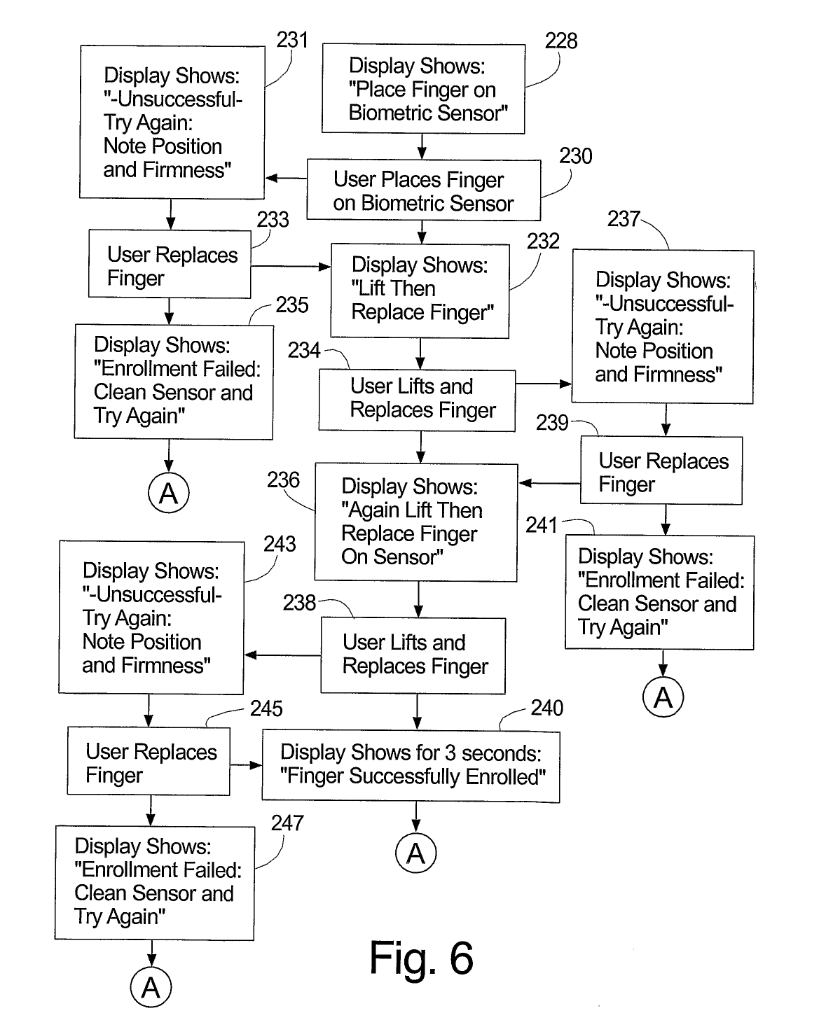

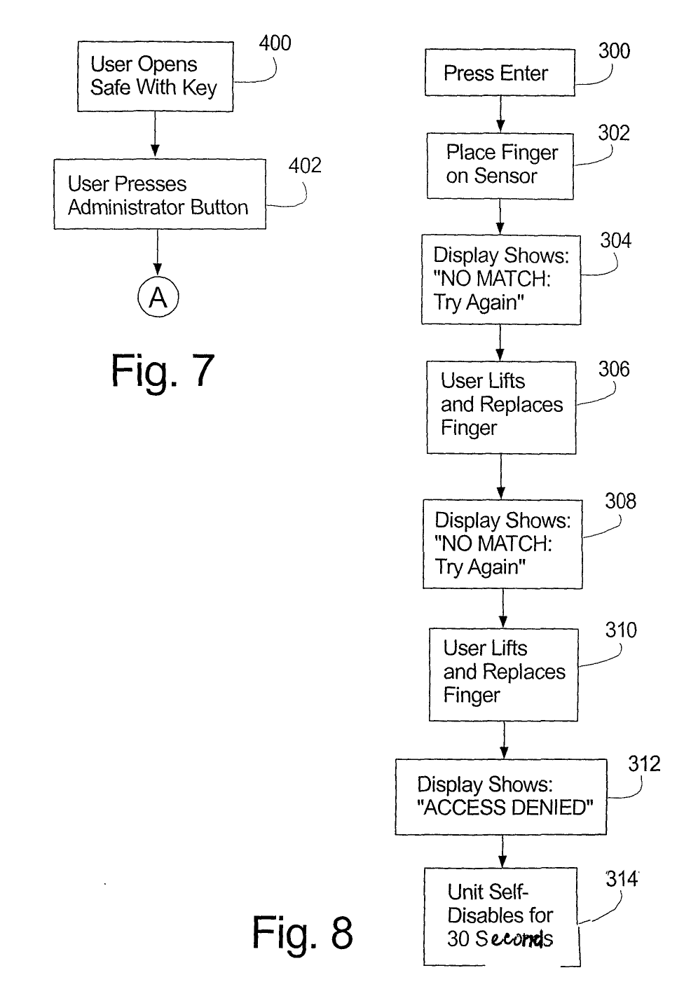

During an attempt to unlock, add or delete a fingerprint from biometric lock 8, biometric lock interface 10 performs a series of sequencing events or steps that provide the user with visual cues, such as written information on display 14 and prompt LED's 26, to assist and provide the user with instructions for operating biometric lock 8. Biometric lock 8 may perform different sequencing events in situations where a valid user opens safe 6 (FIG. 4), a manager opens safe 6 or enrolls/deletes fingerprints from biometric lock 8 (FIGS. 5 and 6), entering an administration mode by using administration button 50 (FIG. 7), and a entry attempt where the biometric feature of the user does not match (FIG. 8).

As best seen in FIG. 4, biometric lock 8 may undergo a series of sequencing steps when a valid user attempts to open safe 6. With additional reference to FIGS. 2 and 3, step 100 shows that the user may press the enter button 18 on biometric lock interface 10, which may direct power from battery 34 to the components shown in FIG. 3. At that point, backlight LEDs 26 operate to emit light through surfaces 24 to light up biometric sensor 16, scroll buttons 20, 22 and enter button 18. The backlight LEDs 26 also operate to illuminate display 14. Further, text may appear on display 14 giving an instruction to “Place Finger on Sensor”0 at step 102. Further guidance may be provided on display 14 by showing a symbol such as an arrow pointing toward the biometric sensor 16. At that point, the lighting and written information provided on display 14 directs the user's attention to sensor 16.

In placing the fingerprint on biometric sensor 16, biometric alignment feature 28 will be used to provide a target so that the fingerprint will be properly aligned on sensor 16. Proper alignment may be required to ensure that biometric lock 8 can obtain a proper fingerprint reading. Specifically, the user will use crosshairs 32a, 32b to vertically position the thick portion of the fingerprint on sensor 16, and use crosshairs 30a. 30b to horizontally position the thick portion of the fingerprint on sensor 16. In addition, the user may align his or her finger with crosshairs 30a, 30b so that the fingerprint is in a proper rotational position when placed on sensor 16.

Once the user has properly placed one or more of his or her fingerprints on biometric sensor 16, the fingerprint information is sent to controller 42 to determine if the one or more fingerprints matches a previously stored fingerprint contained within the memory of controller 42. If the fingerprint of the user matches a stored fingerprint in controller 42, controller 42 may then send an encrypted signal to shift register 56. Shift register 56 then sends a signal to identity comparator 60 which sends a signal to actuator interface 62. With addition reference to FIG. 1, actuator interface 62 then activates safe actuator 38 at step 104 to move one or more lock bolts 19 out of engagement with safe body 15 to allow access to safe 6, and then biometric lock 8 shuts off at step 106. The user may then access internal compartment 11 of safe 6 and lock safe 6 by rotating a lock handle 21.

As best seen in FIGS. 5 and 6, biometric lock 8 may undergo a series of sequencing steps when a manager opens safe 6, or wants to add or delete one or more fingerprints from the biometric lock 8. With additional reference to FIGS. 2 and 3, step 200 shows that the user may press the enter button 18 on biometric lock interface 10, which may direct power from battery to the components shown in FIG. 3. At that point, backlight LEDs 26 operate to emit light through surfaces 24 to light up biometric sensor 16, scroll buttons 20, 22 and enter button 18. The backlight LEDs 26 also operate to illuminate display 14. Further, text may appear on display 14 giving an instruction to “Place Finger on Sensor”0 at step 202. Further guidance may be provided on display 14 by showing a symbol such as an arrow pointing toward the biometric sensor 16. At that point, the lighting and written information provided on display 14, directs the user's attention to sensor 16.

In placing the fingerprint on biometric sensor 16, alignment feature 28 will be used to provide a target so that the fingerprint will be properly aligned on sensor 16. Proper alignment may be required to ensure that biometric lock 8 can obtain a proper fingerprint reading. Specifically, the user will use crosshairs 32a, 32b to vertically position the thick portion of the fingerprint on sensor 16, and use crosshairs 30a, 30b to horizontally position the thick portion of the fingerprint on sensor 16. In addition, the user may align his or her finger with crosshairs 30a, 30b so that the fingerprint is in a proper rotational position when placed on sensor 16.

Once the user has properly placed one or more of his or her fingerprints on biometric sensor 16, the fingerprint information is sent to controller 42 to determine if the one or more fingerprints matches a previously stored fingerprint contained within the memory of controller 42. If the fingerprint matches a stored fingerprint in controller 42, at least the backlight LED 26 emitting light on sensor 16 may shut off indicating that a valid fingerprint has been read by controller 42. At that point, the controller 42 may then send an encrypted signal to shift register 56. Shift register 56 then sends a signal to identity comparator 60 which sends a signal to actuator interface 62. Actuator interface 62 then activates safe actuator 38 at step 204 to unlock safe 6.

Furthermore, after biometric lock 8 recognizes that the one or more fingerprints corresponds to one or more of the managers, text may appear on display 14 giving an instruction to “Press ENTER to enroll/delete”0 at step 206. If the manager would like to add/delete a fingerprint stored in the memory of controller 42, the manager may press the enter button 18 at step 208. The display 14 will then show text that make up one or more selections that may include “User 1 Finger 1*, User 1 Finger 2, User 2 Finger 1*, Exit, etc. . .”0 at step 210. The asterisk (“*”) positioned in association with a selection indicates that fingerprint information is stored in the memory assigned to that particular selection. Therefore, if the manager wants to add or enroll a new fingerprint in a memory location (User 1 Finger 1*) that already has a fingerprint stored therein, manager may be required to delete the fingerprint information that is stored in the memory location. The manager may delete a stored fingerprint by locating the memory location that he or she wants to delete by scrolling through the available memory locations with scroll buttons 30, 32 and selecting, for example, “User 1 Finger 1*”0 using the enter button 18 at step 212. At step 214, display 14 may then display the selected memory location (i.e., User 1, Finger 1) and ask the manager whether this is the fingerprint that should be deleted using “YES” and “NO”0 selections that may be scrolled through by the manager using buttons 20, 22. If the manager selects “NO”0 at step 214, the sequencing will return to step 210. If the displayed fingerprint is the one that is to be deleted, the manager selects “YES”0 by pressing the enter button 18 at step 216. The fingerprint stored in the memory of controller 42 will then be deleted. At step 218, the display 14 will then confirm that the deletion has taken place by displaying text that reads “User 1 Finger 1: DELETED.”0 At that point, the sequencing of biometric interface 10 will return to step 210.

At step 210, the manager may also enroll a new fingerprint in a memory location that does not have a fingerprint stored therein, or in a location in which a fingerprint has been deleted. The manager may add a fingerprint to the controller 42 memory by locating the memory location that he or she wants to store a new fingerprint by scrolling through the available memory locations with scroll buttons 30, 32 and selecting, for example, “User 1 Finger 2”0 using the enter button 18 at step 220. At step 222, display 14 may then display the selected memory location (i.e., User 1, Finger 2) and ask the manager whether this is the location in which the fingerprint should be added using “YES”0 and “NO”0 selections that may be scrolled through by the manager using buttons 20, 22. If the manager selects “NO”0 at step 222, the sequencing will return to step 210. If the displayed fingerprint storage location is the desired location for storing the added fingerprint, the manager selects “YES”0 by pressing the enter button 18 at step 224. The fingerprint may then be stored in the memory of controller 42 by proceeding through one or more sequencing events in step 226. At step 226, the biometric lock 8 requests the unique identifying characteristic and may proceed to enroll the fingerprint through a series of steps described in FIG. 6.

The biometric interface 10 may go through a series of sequencing steps to enroll a unique identifying characteristic at step 226, as best seen in FIG. 6. In particular, display 14 may show text that directs the manager to “Place finger on sensor”0 at step 228. Further, display 14 may also have symbols such as arrows and backlight LED 26 that may be turned on to emit light on sensor 16 to direct the manager's attention to the biometric sensor 16. The manager may then place his or her fingerprint on biometric sensor 16 so that an initial reading can be taken at step 230. The display 14 will then display text that reads “Lift then replace finger”0 at step 232 and the biometric interface 10 may provide additional visual cues, such as lighting through surface 24 located in recess 33, to direct or indicate to the manager to place his or her fingerprint on biometric sensor 16. The manager may then place his or her fingerprint on biometric sensor 16 so that second reading can be taken at step 234. The display 14 will then display text that reads “Again lift then replace finger”0 at step 236 and the biometric interface 10 may provide visual cues, such as lighting through surface 24 located in recess 33, to direct or indicate to the manager to place his or her fingerprint on biometric sensor 16 for a third reading. The manager may then place his or her fingerprint on biometric sensor 16 so that the third reading can be taken at step 238. If the image quality of all the fingerprint readings were adequate, display 14 will show text that reads “Finger successfully enrolled”0 for three seconds at step 240 and then proceed back to step 210 in FIG. 5.

If the image quality of any of the fingerprints taken at any one of steps 230, 234, 238 is not adequate, display 14 may show text that reads “-Unsuccessful-Try Again: Note position and firmness”0 at steps 231, 237, 243. The manager may then replace his or her finger on biometric sensor 16 at steps 233, 239, 245 and proceed with the enrollment process at the next successive step 232, 236 or 240, respectively. If too many poor images are obtained by biometric lock 8 at steps 233, 239, 245, enrollment may fail at steps 235, 241, 247 and display 14 may show text that reads “Enrollment failed: Clean sensor and try again.”0 The sequencing will then proceed to step 210 in FIG. 5.

As best seen in FIG. 8, the biometric lock also has a sequencing that it undergoes for an entry attempt where a biometric does not match. As with the other sequencing events, the biometric lock 8 is initiated by using the enter button 18 on biometric interface 10. In particular, with additional reference to FIGS. 2 and 3, step 300 shows that the user may press the enter button 18 on biometric lock interface 10, which directs power from battery to the components shown in FIG. 3. At that point, backlight LEDs 26 operate to emit light through surfaces 24 in recess 33 to light up biometric sensor 16 scroll buttons 20, 22 and enter button 18. The backlight LEDs 26 also operate to illuminate display 14. Further, text may appear on display 14 providing an instruction to “Place Finger on Sensor”0 at step 302. Further guidance may be provided on display 14 by showing a symbol such as an arrow pointing toward the biometric sensor 16. At that point, the lighting and written information provided on display 14 directs the user's attention to sensor 16. After the fingerprint is read by biometric sensor 16 and controller 42 does not recognize the user as one of the fingerprints stored therein, display 14 may show text that reads “NO MATCH: Try Again”0 at step 304. At step 306, the fingerprint is then replaced on biometric sensor 16 and compared with the fingerprints stored in the memory of controller 42. If the fingerprint does not match any of the stored fingerprints, display 14 may show text that reads “NO MATCH: Try Again”0 at step 308. In a third or final attempt to gain access to safe 6, the fingerprint is again placed on biometric sensor 16 at step 310. If the controller 42 does not recognize the fingerprint during this third and final attempt, display 14 may show text that reads “ACCESS DENIED”0 at step 312 and biometric lock 8 may self-disable for a period of time, for example, 30 seconds, at step 314. While the present sequencing example allows for three chances to enter a valid fingerprint in steps 302, 306, 310, it will be understood that more or less chances may be implemented.

In order to access the administration mode that will allow all of the fingerprints stored in the controller 42 memory to be deleted or erased, the steps shown in FIG. 7 may be followed. First, the administrator uses a key to unlock the conventional locking mechanism at step 400, which enables the administrator to bypass the biometric lock 8 and gain access to internal compartment 11 of safe 6. As the administrator is moving the conventional locking mechanism from a locked position to an unlocked position, lock axis 64 and cam member 66 are rotated counterclockwise, as best seen in FIGS. 9 and 10 thereby rotating cam member 66 allows access to administration button 50. With administrator button 50 being in an exposed position, the administrator may then press administration button 50 at step 402 to erase all of the fingerprints stored in the memory of controller 42. The sequencing of biometric lock 8 would then move to step 210 in FIG. 5 as described above.

The present invention overcomes and ameliorates the drawbacks and deficiencies in the prior art. Specifically, the biometric lock of the present invention includes a number of visual cues, such as instructions and symbols provided on a display, prompt LEDs, and a biometric alignment feature, to make the unlocking of safe 6 easier and more efficient than a safe equipped with only audible indicators. Moreover, the present invention includes an administrator locking mechanism that prevents users who are not administrators of the biometric lock from gaining access to the administrator button and erasing all of the fingerprints stored in the controller memory, thereby taking control of the biometric lock.

Although the present invention has been described in considerable detail with reference to certain preferred versions thereof, other versions are possible. Therefore, the spirit and scope of the appended claims should not be limited to the description of the preferred versions contained herein.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A lock interface for a biometric lock, the biometric lock being adapted to selectively restrict access to an enclosure, the lock interface comprising:
a body;
a biometric sensor mounted to the body for reading a unique identifying characteristic of an individual; and
a biometric alignment feature associated with the biometric sensor to assist a user in properly positioning the unique identifying characteristic with respect to the biometric sensor.

2. The lock interface recited in claim 1, wherein the biometric sensor is rectangular and includes a top boundary, a bottom boundary, a right boundary and a left boundary.

3. The lock interface recited in claim 2, wherein the biometric alignment feature includes a first crosshair positioned adjacent to the top boundary, a second crosshair positioned adjacent to the bottom boundary, a third crosshair positioned adjacent to the right boundary, and a fourth crosshair positioned adjacent to the left boundary, wherein the first crosshair, second crosshair, third crosshair, and fourth crosshair provide a guide for placing the unique identifying characteristic on the biometric sensor.

4. The lock interface recited in claim 3, wherein the first and second crosshairs are perpendicular to the third and fourth crosshairs.

5. The lock interface recited in claim 3, wherein the biometric sensor has a first axis that bisects the top and bottom boundaries, and a second axis that bisects the right and left boundaries, wherein the first and second crosshairs lie on the first axis, and wherein the third and fourth crosshairs lie on the second axis.

6. The lock interface recited in claim 5, wherein the first and second axes are perpendicular.

7. The lock interface recited in claim 1, wherein the biometric sensor is a capacitive sensor.

8. The lock interface recited in claim 1, wherein the unique identifying characteristic is a fingerprint.

9. The lock interface recited in claim 1, further comprising a light emitting mechanism associated with the biometric sensor for selectively illuminating the biometric sensor.

10. The lock interface recited in claim 9, wherein the a light emitting mechanism is a light emitting diode.

11. The lock interface recited in claim 9, wherein a first portion of the body is formed of a material that allows light to pass therethrough, wherein the light emitted by the light emitting mechanism is directed through the first portion and onto the biometric sensor.

12. The lock interface recited in claim 1, further comprising a display coupled with the body for conveying information to a user of the biometric lock.

13. An enclosure including a body and a door that define an interior compartment, the door being hingedly mounted to a body of the enclosure, the enclosure comprising:
a biometric lock coupled with the enclosure that may be used to selectively lock and unlock the door relative to the body of the enclosure, the biometric lock including a controller, a biometric sensor, and an administrator function, the biometric sensor being mounted to the body of the enclosure for reading a unique identifying characteristic of an individual, the controller having a memory for storing at least one fingerprint read by the biometric sensor, wherein the administrator function is adapted to clear the at least one unique identifying characteristic stored in the memory;
a key lock coupled to the enclosure to selectively lock and unlock the door of the enclosure, wherein the biometric lock and the key lock independently operate to selectively lock and unlock the door of the enclosure; and
an administrator locking mechanism including an axis and a cam member, the axis coupled with the cam member and being adapted to change the position of the cam member when the key lock is moved between locked and unlocked positions, wherein the cam member positioned to restrict access to the administrator function when the key lock is in a locked position, and wherein the cam member is positioned to allow access to the administrator function when the key lock is in an unlocked position.

14. The enclosure recited in claim 13, wherein the enclosure includes an actuator that operates to lock and unlock the door relative to the body of the enclosure, wherein the cam member interacts with the actuator to unlock the safe when the key lock is moved to an unlocked position.

15. A method for unlocking a safe using a biometric lock, the biometric lock including a locking mechanism and a lock interface having a biometric sensor and a display, the method comprising:
initiating the biometric lock by contacting at least a portion of the lock interface;
recognizing a visual cue that indicates that a unique identifying characteristic is to be entered using the biometric sensor; and
entering the unique identifying characteristic feature using the biometric sensor, wherein the entered unique identifying characteristic is compared with a stored unique identifying characteristic of an authorized user stored in a memory location within the biometric lock, wherein the safe is unlocked if the entered unique identifying characteristic matches the stored unique identifying characteristic of an authorized user, and wherein the safe remains locked if the entered unique identifying characteristic does not match the stored unique identifying characteristic of an authorized user.

16. The method of claim 15, wherein the visual cue is information displayed on the display.

17. The method of claim 16, wherein said information is at least one of text and a symbol.

18. The method of claim 15, wherein the visual cue is at least one of light emitted onto the biometric sensor and a biometric alignment feature positioned in association with the biometric sensor.

19. The method of claim 18, wherein the biometric sensor is rectangular and includes a top boundary, a bottom boundary, a right boundary and a left boundary, wherein the biometric alignment feature includes a first crosshair positioned adjacent to the top boundary, a second crosshair positioned adjacent to the bottom boundary, a third crosshair positioned adjacent to the right boundary, and a fourth crosshair positioned adjacent to the left boundary, wherein the first crosshair, second crosshair, third crosshair, and fourth crosshair provide a guide for placing of the unique identifying characteristic on the biometric sensor.

20. The method of claim 19, wherein the biometric sensor has a first axis that bisects the top and bottom boundaries, and a second axis that bisects the right and left boundaries, wherein the first and second crosshairs lie on the first axis, and wherein the third and fourth crosshairs lie on the second axis.

21. The method of claim 19, wherein the first and second axes are perpendicular.

22. A method for unlocking a safe using a biometric lock, the biometric lock including a locking mechanism and a lock interface having a biometric sensor and a display, the method comprising:
providing the ability to initiate the biometric lock by contacting at least a portion of the lock interface;
providing a visual cue that indicates that a unique identifying characteristic is to be entered using the biometric sensor;
providing the ability to enter the unique identifying characteristic feature using the biometric sensor; and
comparing the entered unique identifying characteristic with a stored unique identifying characteristic of an authorized user stored in a memory location within the biometric lock, wherein the safe is unlocked if the entered unique identifying characteristic matches the stored unique identifying characteristic of an authorized user, and wherein the safe remains locked if the entered unique identifying characteristic does not match the stored unique identifying characteristic of an authorized user.
